(19) United States
(12) Patent Application Publication
(10) Pub. No.: US 2018/0225583 A1
(43) Pub. Date: Aug. 9, 2018

(54) PROACTIVE USER EXPERIENCE

(71) Applicant: COURSERA, INC., Mountain View, CA (US)

(72) Inventors: Zhenghao CHEN, Palo Alto, CA (US); Chuong DO, Mountain View, CA (US); Jiquan NGIAM, Mountain View, CA (US)

(21) Appl. No.: 15/428,664

(22) Filed: Feb. 9, 2017

(51) Int. Cl. G06N 7/00

(52) U.S. Cl. CPC G06N 7/005; G06F 8/61

(57) ABSTRACT

In one general aspect, a method can include identifying a current user state, associating a first action and a second action with the current user state, associating a first value and a first probability with a first new user state based on a possible performing of the first action in the current user state, associating a second value and a second probability with a second new user state based on a possible performing of the second action in the current user state, calculating a first overall value for the first action based on the first value and the first probability, calculating a second overall value for the second action based on the second value and the second probability, and providing the first action to the computing device based on determining that the first overall value is greater than the second overall value.

### TECHNICAL FIELD

This description generally relates to the use of behavioral data and a user state to customize communications with the user.

### BACKGROUND

A provider of a web application can regularly communicate with a user of the application. For example, the provider can make the user aware of other applications of interest to the user that the provider can provide to the user. In another example, the provider can offer recommendations to the user. In yet another example, the provider can offer products for sale that are available for purchase by the user. The provider can communicate with the user in many ways, such as by email, phone, or Short Message Service (SMS) text messaging.

### SUMMARY

According to one general aspect, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a computer-implemented method can include identifying, by a computer system, a current user state, identifying a first action and a second action for association with the current user state, associating a first probability with a first new user state based on a possible performing of the first action in the current user state resulting in the first new user state, associating a second probability with a second new user state based on a possible performing of the second action in the current user state resulting in the second new user state, associating a first value with the first new user state, associating a second value with the second new user state, calculating a first overall value for the first action based on the first value and the first probability, calculating a second overall value for the second action based on the second value and the second probability, determining whether the first overall value is greater than the second overall value, and providing, by the computer system and to a computing device, the first action to the computing device based on determining that the first overall value is greater than the second overall value.

Implementations can include one or more of the following features, alone or in combination with one or more other features. For example, the method can further include providing, by the computer system and to a computing device, the second action to the computing device based on determining that the second overall value is greater than the first overall value. The method can further include associating a third probability with a third new user state based on a possible performing of the first action in the current user state resulting in the third new user state. The method can further include associating a third value with the third new user state. Calculating the first overall value for the first action can be further based on the third value and the third probability. The method can further include receiving, by the computer system and from the computing device, data representative of interactions with an action. The method can further include storing, by the computer system and in a database, the data representative of the interactions with the action. The database can include user data records. The storing of the data representative of the interactions with the action can be stored in the user data records. The first value and the second value can be provided by a state-value model.

In another general aspect, a system can include a database including a plurality of user data records, a user state modeling module, an action modeling module, and an action decision module. The user state modeling module can be configured to receive user data from the plurality of user data records and output a current user state. The action modeling module can be configured to receive the current user state, output a current state/first action pair including a first probability associated with a first new user state based on a possible performing of the first action in the current user state resulting in the first new user state, output a current state/second action pair including a second probability associated with a second new user state based on a possible performing of the second action in the current user state resulting in the second new user state. The action decision module can be configured to receive the current state/first action pair and the current state/second action pair, associate a first value with the first new user state included in the current state/first action pair, associate a second value with the second new user state included in the current state/second action pair, calculate a first overall value for the first action based on the first value and the first probability, calculate a second overall value for the second action based on the second value and the second probability, determine whether the first overall value is greater than the second overall value, and output the first action based on determining that the first overall value is greater than the second overall value.

Implementations can include one or more of the following features, alone or in combination with one or more other features. For example, the action modeling module can be further configured to output the current state/first action pair further including a third probability associated with a third new user state based on a possible performing of the first action in the current user state resulting in the third new user state. The action decision module can be further configured to associate a third value with the third new user state included in the current state/first action pair, and calculate the first overall value for the first action further based on the third value and the third probability. The plurality of user data records can include data representative of interactions with one or more actions. The system can further include a state-value model configured to provide the first value and the second value. The system can further include a user state table configured to store the first user state and the second user state. The system can further include action performing services configured to receive the first action, and include one or more services for providing the action to a computing device.

In yet another general aspect, a non-transitory, machine-readable medium has instructions stored thereon. The instructions, when executed by a processor, can cause a computer system to identify, by the computer system, a current user state, identify a first action and a second action for association with the current user state, associate a first probability with a first new user state based on a possible performing of the first action in the current user state resulting in the first new user state, associate a second probability with a second new user state based on a possible performing of the second action in the current user state resulting in the second new user state, associate a first value with the first new user state, associate a second value with the second new user state, calculate a first overall value for the first action based on the first value and the first probability, calculate a second overall value for the second action based on the second value and the second probability, determine whether the first overall value is greater than the second overall value, and provide, by the computer system and to a computing device, the first action to the computing device based on determining that the first overall value is greater than the second overall value.

Implementations can include one or more of the following features, alone or in combination with one or more other features. For example, the instructions, when executed by the processor, can further cause the computer system to provide, to a computing device, the second action to the computing device based on determining that the second overall value is greater than the first overall value. the instructions, when executed by the processor, can further cause the computer system to associate a third probability with a third new user state based on a possible performing of the first action in the current user state resulting in the third new user state. The instructions, when executed by the processor, can further cause the computer system to associate a third value with the third new user state. Calculating the first overall value for the first action can be further based on the third value and the third probability. The instructions, when executed by the processor, further cause the computer system to receive, from the computing device, data representative of interactions with the action, and store the data representative of the interactions with the action. The first value and the second value can be provided by a state-value model.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system that can provide a proactive user experience.

FIG. 2 is a block diagram of a flowchart showing an example proactive user experience process.

FIG. 3 is a diagram showing a table that includes a column listing for a new state and a column listing for a probability for a particular action transitioning a user from a current state to the new state.

FIG. 4 is a diagram showing a process for evaluating user state/possible action pairs for a particular potential action for a current state of a user.

FIG. 5 is a diagram showing a table that includes a column listing for a new state, a column listing for a probability for a particular action, and a column listing for an estimated value for each new state listed in the new state column.

FIG. 6 is an illustration of an example recommendation email message that a messaging service included in action performing service(s) can provide as an action to a computing device of a user.

FIG. 7 is an illustration of an example on-platform message to a user.

FIG. 8 is a flowchart that illustrates a method for providing a proactive user experience.

FIG. 9 shows an example of a computer device and a mobile computer device that can be used to implement the techniques described here.

Like reference symbols in the various drawings indicate like elements.

### DETAILED DESCRIPTION

A web application can be enabled to (configured to) gather behavioral data, feedback, and other types of descriptive sources of data related to how a user interacts with the web application. In some cases, data external to the user but relevant to a particular current event may also be included in the gathered data. The web application can aggregate the gathered data and information related to the interaction of the user and, for example, store it in a database or repository. A provider of the web application can further provide methods and systems that can access the gathered data and information and use it in a state-value model whose input is a current user state and whose output is an estimated value of a user in the current state. The estimated value of the user can be defined in multiple different ways. The state-value model can evaluate a current state/possible action pair to determine a probability of the user transitioning from the current state to another state when a particular action is performed on the user. A value can be associated with each possible state transition. A decision as to what a best action to take is can be based on the state-value model by selecting the action with the highest estimated value based on considering the potential states reachable from the current state, the probability of the user transitioning from the current state to each potential state given the action, and the value associated with the transition. The methods and systems can determine a response of the user to the action and can use this information to improve the state-value model.

Web application platforms may not proactively interact with a user. The web application platform may be more reactive in that a user indicates what they want to do (e.g., web pages they want to visit, information they request). A proactive user experience can take into account a long-term state and activities of a user of a web application. Instead of a user indicating what they want, the web application can proactively provide a user with what they need based on past user activities and behavior. For example, if a user when launching the web application frequently visits a particular web page, when the web application is launched it can automatically transition to the web page. A proactive user model can move r place a user into a desired state. This can result in short-term actions of a user leading to long-term outcomes or state changes.

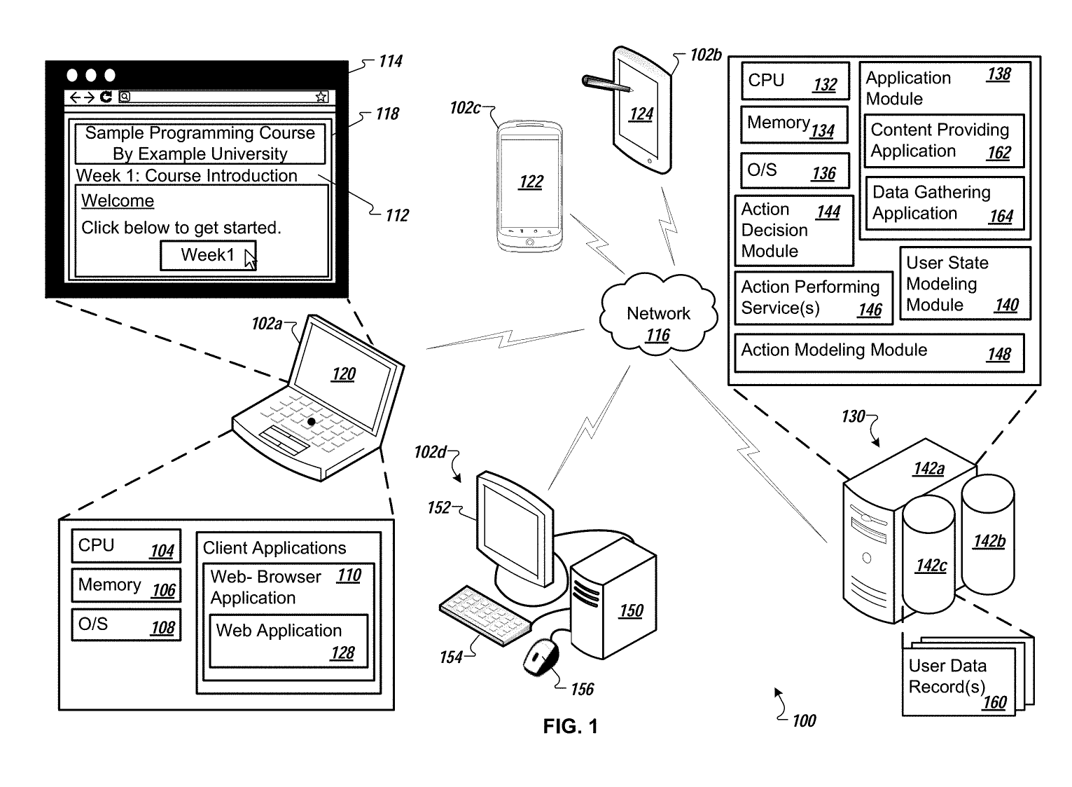

FIG. 1 is a diagram of an example system 100 that can provide a proactive user experience. The system 100 includes a plurality of computing devices 102a-d (e.g., a laptop or notebook computer, a tablet computer, a smartphone, and a desktop computer, respectively). The system 100 includes a computer system 130 that can include one or more computing devices (e.g., a server 142a) and one or more computer-readable storage devices (e.g., a database 142b and a database 142c).

An example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110. The web browser application 110 can execute one or more web applications (e.g., a web application 128).

The server 142a included in the computer system 130 can include one or more processors (e.g., a server CPU 132), and one or more memory devices (e.g., a server memory 134). The computing devices 102a-d can communicate with the computer system 130 (and the computer system 130 can communicate with the computing devices 102a-d) using a network 116. The server 142a can execute a server O/S 136. For example, the server 142a can provide content that can be included in (stored in) the database 142b, where the database 142b can be considered a repository. The server 142a can include an application module 138. The application module 138 can provide the content (e.g., a video of an online course) to the computing devices 102a-d using the network 116.

In some implementations, the computing devices 102a-d can be laptop or desktop computers, smartphones, personal digital assistants, tablet computers, or other appropriate computing devices that can communicate, using the network 116, with other computing devices or computer systems. In some implementations, the computing devices 102a-d can perform client-side operations, as discussed in further detail herein. Implementations and functions of the system 100 described herein with reference to computing device 102a, may also be applied to computing device 102b, computing device 102c, and computing device 102d and other computing devices not shown in FIG. 1 that may also be included in the system 100.

The computing device 102a includes a display device 120. In some implementations, the display device 120 can be a touchscreen. The computing device 102b includes a display area 124 that can be a touchscreen. The computing device 102c includes a display area 122 that can be a touchscreen. The computing device 102d can be a desktop computer system that includes a desktop computer 150, a display device 152 that can be a touchscreen, a keyboard 154, and a pointing device (e.g., a mouse 156). A user can interact with one or more input devices and/or a touchscreen to hover over text or icons included in a user interface displayed on a display device.

In some implementations, the computer system 130 can represent more than one computing device working together to perform server-side operations. For example, though not shown in FIG. 1, the system 100 can include a computer system that includes multiple servers (computing devices) working together to perform server-side operations. In this example, a single proprietor can provide the multiple servers. In some cases, the one or more of the multiple servers can provide other functionalities for the proprietor.

In some implementations, the network 116 can be a public communications network (e.g., the Internet, cellular data network, dialup modems over a telephone network) or a private communications network (e.g., private LAN, leased lines). In some implementations, the computing devices 102a-d can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the web browser application 110 can execute or interpret a web application 128 (e.g., a browser-based application). The web browser application 110 can include a dedicated user interface (e.g., a web browser UI 114). The web application 128 can include code written in a scripting language, such as AJAX, JavaScript, VBScript, ActionScript, or other scripting languages. The web application 128 can display a web page 118 in the web browser UI 114. The web page 118 can include a graphical user interface (GUI) 112.

For example, the computing device 102a can receive a video of an online video course from the computer system 130. For example, the web application 128 can display in the web browser UI 114 one or more icons representative of (associated with) respective one or more courses for selection by a user of the computing device 102a. For example, the user can select a course by placing a cursor on an icon. The user can then select the icon (e.g., click a mouse button). The selection of the icon can launch the online course. When launched, the computer system 130 can provide the video of the online course. The display device 120 can display the visual content of the video of the online course and one or more speakers (not shown) included in the computing device 102a can play the audio portion of the online course.

For example, a content providing application 162 included in the application module 138 can be launched. The content providing application 162 can retrieve a video of an online course from the database 142b. The server 142a using the network 116 can provide the video of the online course to the computing device 102a. A data gathering application 164 included in the application module 138 can receive data and information representative of interactions of a user (or learner) with the online course. The data gathering application 164 can provide the data and information to the database 142c for storage in user data record(s) 160. In addition, the application module 138 can interface with one or more of a user state modeling module 140, an action decision module 144, action performing service(s) 146, and an action modeling module 148. The computer system 130 can execute one or more software applications included in the application module 138, the user state modeling module 140, the action decision module 144, the action performing service(s) 146, and the action modeling module 148 to provide a proactive user experience to a learner (e.g., a learner interacting with (enrolled in) an online course included in the database 142b and provided by the application module 138).

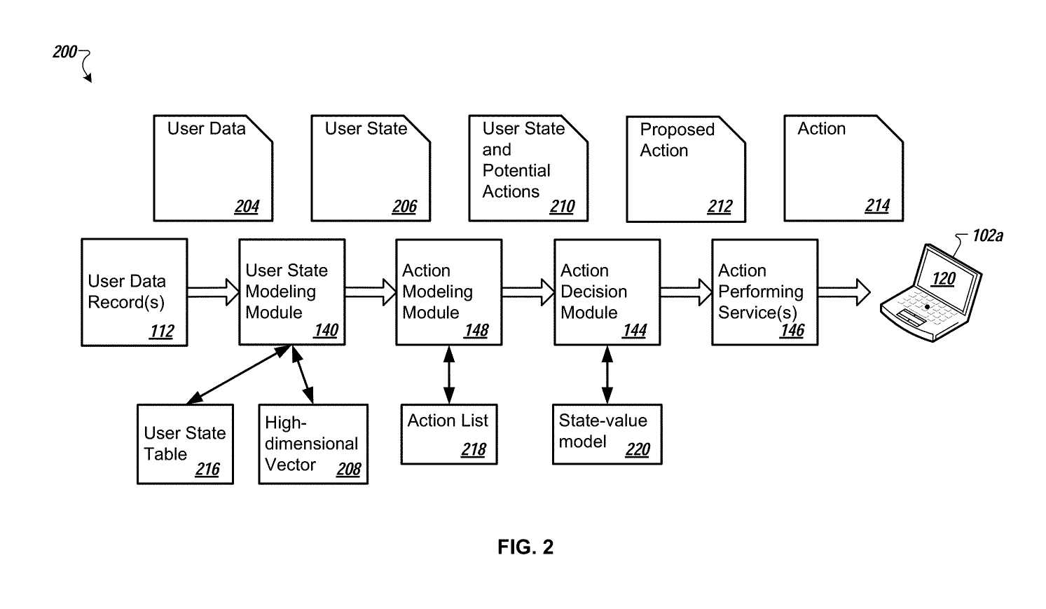

FIG. 2 is a block diagram of a flowchart showing an example proactive user experience process 200.

Referring to FIG. 1, the user state modeling module 140 can include software and hardware that can that can access the database 142c. In some implementations, the database 142c can include multiple databases that the server 142a can access. The user state modeling module 140 can receive various forms of information and data associated with one or more users or learners. The information and data (e.g., user data 204) can be included in (stored in) one or more of the multiple databases (e.g., the user data record(s) 160 included in (stored in) the database 142c). For example, the user state modeling module 140 can receive the user data record(s) 160 included in the database 142c as the user data 204. The user data record(s) 160 can include (store) information and data associated with users and learners. The information and data can include historical interaction data. The historical interaction data can be related to the interaction of a user with one or more web pages for a web application. For example, the historical interaction data can be related to the interaction of a learner with an online course. In another example, the historical interaction data can be related to interactions of a user with a web page for the online course provider. The web page can be accessed by a user of the computing device 102a using the web browser application 110 (e.g., the web application 128).

In some implementations, the user state modeling module 140 analyzes the user data 204 and outputs a user state 206. For example, the user state can be one of a total number (N) of possible discrete user states included in a listing or table of user states (e.g., user state table 216) generated by the user state modeling module 140. In some implementations, the user state modeling module 140 analyzes the user data 204 and generates a high-dimensional probability vector 208. The high-dimensional probability vector 208 can provide positions (indices) that represent a total number (n) of possible discrete user states. In addition, the high-dimensional probability vector 208 can provide a probability for each discrete user state. In some implementations, the user state table 216 and/or the high-dimensional probability vector 208 can be stored in (included in) a repository in the system 100 (e.g., the database 142b and/or the database 142c and/or another database or repository accessible by the server 142a).

The action modeling module 148 can evaluate an effect of one or more actions on a current user state. The actions can include types and contents of communications that can be provided to the user or to other individuals that may be associated with the user of the provider of the web application 128 (e.g., an online course provider). The one or more actions can be included in an action list 218. For example, the action list 218 can be a list or a table of possible actions that can be stored in (included in) a repository in the system 100 (e.g., the database 142b and/or the database 142c and/or another database or repository accessible by the server 142a).

The effect of an action can be a response to the communication that is provided by the individual who received the communication and that effects the current state of the user. For example, responsive to the communication a user may further interact with the web application 128 in a particular manner. The further interactions can result in information and data related to the interactions being provided to the application module 138 for further inclusion in the user data record(s) 160 stored in the database 142c.

The action modeling module 148 can predict a new user state based on a current user state and a potential action to perform. The action modeling module 148 can predict a new user state based on data and information stored in the user data record(s) 160. The data and information stored in the user data record(s) can include past (previous) examples of one or more user states before and after a particular action was performed on the state. The action modeling module 148 can generate a predictive model of one or more possible new user states based on a current user state and a potential action that is performed on the current user state. In some implementations, the user state table 216 and/or the high-dimensional probability vector 208 can be stored in (included in) a repository in the system 100 (e.g., the database 142b and/or the database 142c and/or another database or repository accessible by the server 142a).

The action decision module 144 can receive as input one or more current state/possible action pairs as user state and potential actions 210 from the action modeling module 148. The user state and potential actions 210 can provide a probability and distribution of one or more possible new states for a user based on the performing of a particular action. The action decision module 144 can use the user state and potential actions 210 along with information and data provided by a state-value model 220 to identify the best action to take. The state-value model 220 can include an associated estimated value for the user when in that particular state. The value associated with a user when in a particular state can be dependent on the provider of the web application 128. In some implementations, the state-value model 220 can be stored in (included in) a repository in the system 100 (e.g., the database 142b and/or the database 142c and/or another database or repository accessible by the server 142a). For example, a time-based revenue may be associated with a user and can be considered the value associated with the user when the user is in a particular state. The time-based revenue can be an amount of revenue a user may provide to the provider during a particular time frame (e.g., six months).

The action decision module 144 can determine a proposed action 212 and provide the proposed action 212 to the action performing service(s) 146. The action performing service(s) 146 can provide the proposed action 212 as an action 214 to be performed on the computing device 102a. For example, the proposed action 212 can be the sending of an email to a user related to upselling the user (e.g., notifying the user of additional courses provided by an online course provider). The action 214 can be the sending of an email by the action performing service(s) included on the server 142a to the computing device 102a.

Referring to FIG. 1, for example, an action (e.g., the action 214) may prompt the user to interact further with a web application (e.g., the web application 128). For example, the action 214 may be a reminder to a learner to complete a survey for an online course. The additional interactions (e.g., how and when the learner completed the survey) can generate additional user data. In the example where the user is a learner in an online course provided by the application module 138 included in the computer system 130, the user can interact with the web application 128 in the web browser application 110 on the computing device 102a. The web application 128 can provide the results of the interactions to the application module 138. The application module 138 can gather and store the additional user data in the database 142c. In some cases, storing the additional user data in the database 142c can result in adding additional user data records to existing user data records. In some cases, storing the additional user data in the database 142c can result in the updating of the user data records.

The proactive user experience process 200 can then be repeated using the new and updated user data retrieved from (provided by) the user data record(s) 160 included on the database 142c. The proactive user experience process 200 can be iteratively performed as described, where user interactions with the web application 128 can be provided to the application module 138, stored in the database 142c as new and/or updated user data records, and then retrieved by (provided to) the user state modeling module 140. The user state 206, the user state and potential actions 210, and the proposed action 212 can be changed (or updated) based on the additional and/or updated user data included in the user data records stored in the database 142c. The ability to iteratively perform the proactive user experience process 200 can result in improvements in the proposed action 212. Presenting a user with a proposed action that more clearly predicts a new state for the user based on a current state of a user can result in a positive and proactive experience for the user of the web application 128.

The proactive user experience process 200 can be performed by the system 100 as shown in FIG. 1. For example, the system 100 can be used to provide a user with an online course. As described, the application module 138 can provide the online course as a web application 128 executing in a web browser application 110. A user (or learner) can interact with the web application 128 using one or more input device included in the computing device 102a.

When interacting with the web application 128, the application module 138 (and specifically the data gathering application 164) can be provided with data and information representative of (indicative of, related to, or associated with) one or more interactions of a user with the web application 128. The data gathering application 164 can store the data and information in the database 142c for inclusion in the user data record(s) 160.

Examples of data and information representative of interactions of the user with the web application 128 can include, but are not limited to: information and data representative of the selection by the user of one or more items displayed in a user interface (e.g., the GUI 112) for the web application 128; information and data representative of web pages for the web application 128 that the user has selected and viewed (e.g., the web page 118); information and data representative of the opening of emails by the user within the web application 128 and the possible interactions of the user with information and data provided in the email (e.g., selecting a link (a Uniform Resource Locator (URL)) to another web page provided by the web application 128); information and data representative of the selection, by the user, to view forum postings and interactions, by the user, within forum postings where the forum postings are related to the content provided by the web application 128; and information and data representative of requests, by the user, for support from the provider of the web application 128.

When the content provided by the content providing application 162 is a for an online course, examples of data and information representative of interactions of the user with the web application 128 can include submissions for quizzes and assignments for the online course. When the content provided by the content providing application 162 is a video of an online course, examples of data and information representative of interactions of the user with the web application 128 can include video play, pause, and seek events. Other examples of data and information that can be associated a user (a learner) for an online course can include the scores received for the submitted quizzes and assignments and a list of courses the user may have been previously enrolled in (and completed) and a grade that can be associated with the completed course.

In addition, in some implementations, metadata related to the interactions of the user with the web application 128 can be stored in association with the data and information representative of the specific interaction of the user with the web application 128. The timing and duration of an interaction of the user can be stored in association with the specific interaction of the user. For example, how long a user spent viewing a particular web page can be stored in association with the data and information representative of the web page for the web application 128 that the user selected. In another example, the number of items selected by the user while interacting with the GUI for a particular web page can stored in association with the information and data representative of the selection by the user of the one or more items displayed in the GUI for the web application.

In some implementations, the user may provide additional information and data to the provider of the web application. Example data that can be provided by a user when the user is, for example, a learner enrolled in an online course, can include, but is not limited to, demographic data associated with the user, employment data associated with the user, career goal data associated with the user, and learning goal data provided by the user.

As described herein, the user state modeling module 140 can receive and analyze the user data 204 resulting in the outputting of a user state 206. The action modeling module 148 can receive the user state 206 as a current user state and can evaluate an effect of one or more actions on the current user state.

An example of a potential actions that can be performed on a user can include, but are not limited to, sending a user a list of recommendations, sending a user a reminder, prompting a support specialist for the provider to check-in with the user (e.g., the support specialist sends a message to the user), and sending a user suggestions that are associated with the content provided by the provider. The potential actions of sending information to a user can include the sending of messages to the user. The messages can include, but are not limited to, email messages, SMS text messages, messages displayed in a context of the user when they are using or interacting with the web application 128, and messages posted in forums for the web application. In some implementations, the action performing service(s) 146 can send a plurality of messages in different formats to multiple devices of a user. For example, the action performing service(s) 146 can send an email message to the user for display on the display device 120 included in the computing device 102a. In another example, the action performing service(s) 146 can send an SMS text message to a mobile device of the user (e.g., the computing device 102c which can be, for example, a mobile phone). In another example, the action performing service(s) 146 can send a voicemail message to a mobile device of the user (e.g., the computing device 102c which can be, for example, a mobile phone).

For example, in the case where the user is a learner enrolled in an online course, the sending of a list of recommendations to a user can include sending a list of recommended courses or a list of a sequence of recommended courses for possible future enrollment. For example, in the case where the user is a learner enrolled in an online course, the sending of a reminder to a user can include sending the user a reminder to complete an assignment or a quiz for the online course. For example, in the case where the user is a learner enrolled in an online course, the sending of suggestions to the user can include sending suggestions to the user for external resources or forum postings that may help the user as they proceed through the online course sessions. For example, in the case where the user is a learner enrolled in an online course, a potential action can be the assigning of a mentor to the user. The mentor can help the user resolve any misunderstandings they may have about the course materials. For example, in the case where the user is a learner enrolled in an online course, a potential action can be messaging the user within the platform of the online course. The messaging can include an update stating that the user is on-track with the course material for the next time they log into or access the online course.

Each of the described actions can prompt a user to interact further with the web application 128. The further interactions with the web application 128 can generate additional interaction data that can be provided to the data gathering application 164 for storing in (including in) the database 142c and specifically for including in (as additional data or as updates to existing data) the user data record(s) 160. Because the proactive user experience process 200 can then be repeated (executed iteratively), the additional interaction data can be used by the user state modeling module 140 and the proactive user experience process 200 can be repeated. Repeating the proactive user experience process 200 can result in a new user state, which can be a user state 206 that is different from a previous user state.

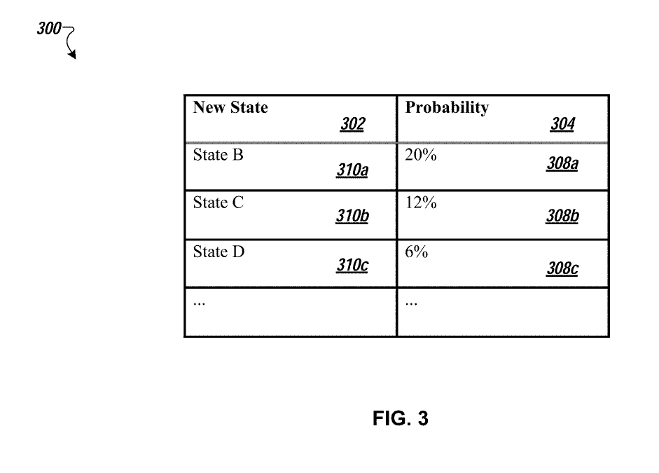

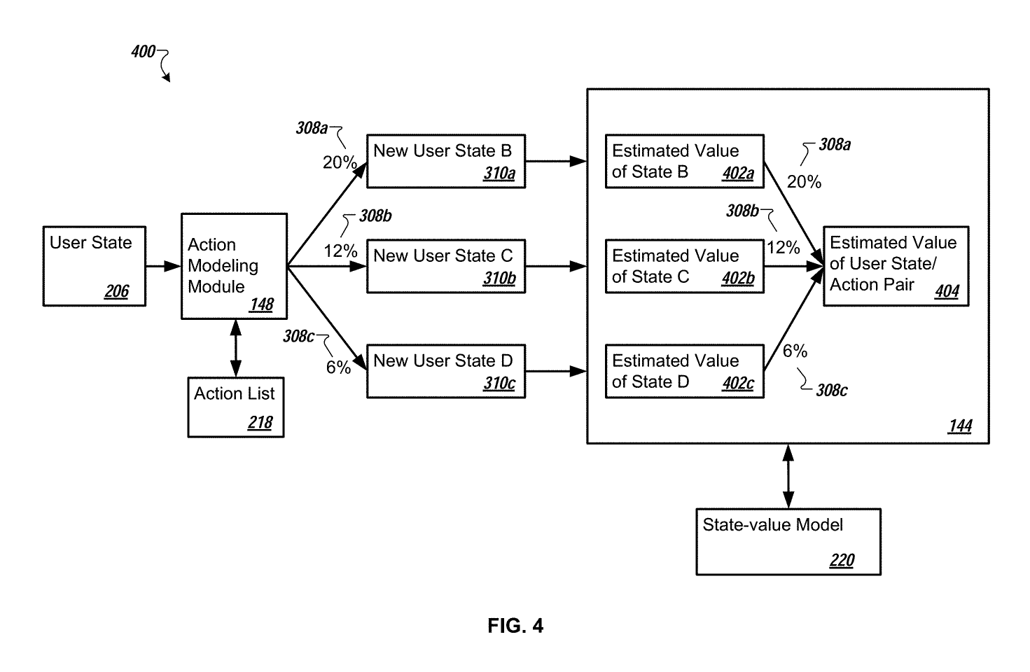

FIG. 3 is a diagram showing a table 300 that includes a column listing for a new state 302 and a column listing for a probability 304 for a particular action (e.g., Action 1) resulting in placing a user in the new state from a current (or previous state). FIG. 4 is a diagram showing a process 400 for evaluating user state/possible action pairs for a particular potential action (e.g., Action 1) for a current state of a user (e.g., State A).

For example, referring to FIGS. 1-4, the action modeling module 148 can receive the user state 206 (e.g., the current state of the user, State A) that is output from the user state modeling module 140. The action modeling module 148 can access the action list 218 that includes a list of actions. The action modeling module 148 can generate the table 300 based on the user state 206 and the data and information included in the action list 218.

The table 300 is an example of a user state/possible action pair (e.g., State A/Action 1) showing a probability 308a-c for a possible new user state (e.g., new user states 310a-c) for a particular action (e.g., Action 1), respectively, if a particular action (e.g., Action 1) is performed while the user is in a current state (e.g., State A). For example, referring to FIGS. 1-4 and table 300, if the current state of the user is State A and Action 1 is performed on the user, the action modeling module 148 predicts that there is a 20% probability 308a that the user will transition to new State B 310a after Action 1 is performed. Further, if the current state of the user is State A and Action 1 is performed on the user, the action modeling module 148 predicts that there is a 12% probability 308b that the user will transition to new State C 310b after Action 1 is performed. Further, if the current state of the user is State A and Action 1 is performed on the user, the action modeling module 148 predicts that there is a 6% probability 308c that the user will transition to new State D 310c after Action 1 is performed. In some cases, the performing of an action on the user when the user is in a particular state may have a probability of not transitioning the user to another, different state. In these cases, the user may remain in the current state even after the action is performed on the user.

In some implementations, multiple tables similar to table 300 can be generated by the action modeling module 148. Each table can be for a different user state/possible action pair where the user state remains the user state 206 (e.g., the current state of the user, State A) but the possible actions are different. For example, for a number of possible user actions, M, the action modeling module 148 can generate up to Mtables. For example, the Mtables can be provided to the action decision module 144 as the user state and potential actions 210.

Each of the possible new user states 310a-c can be input to (received by) the action decision module 144 as user state and potential actions 210. The action decision module 144 can use information and data provided by the state-value model 220 to identify an estimated value 402a-c for each new user state 310a-c, respectively. The estimated value 402a-c for each new user state 310a-c, respectively, can be used along with the probability 308a-c associated with each new user state 310a-c, respectively, to determine an overall estimated value (overall score) of a user state/possible action pair 404 (e.g., State A/Action 1). The process 400 for evaluating user state/possible action pairs can be performed for each user state/potential action pair (e.g., State A/Action 1, State A/Action 2, . . . State A/Action M).

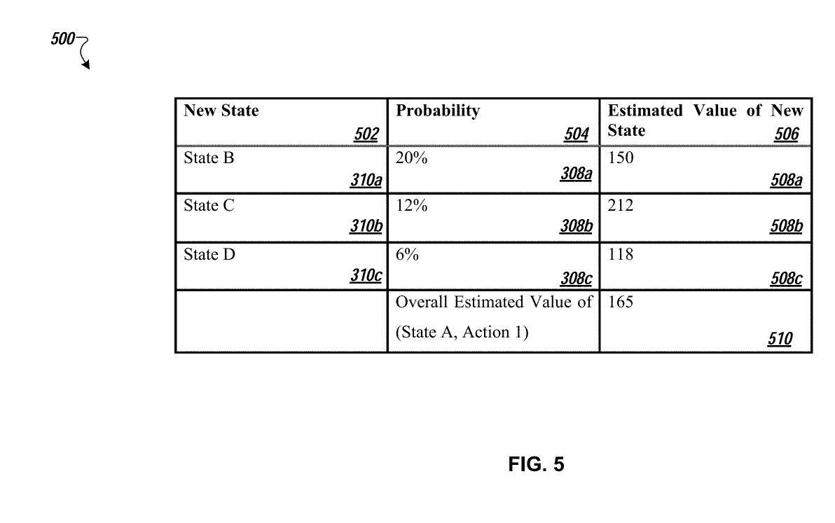

FIG. 5 is a diagram showing a table 500 that includes a column listing for a new state 502, a column listing for a probability 504 for a particular action (e.g., Action 1) resulting in placing a user in the new state from a current (or previous state), and a column listing for an estimated value for each new state (estimated new state value 506) listed in the new state column 502.

Table 500 can be an extension of the table 300 as shown in FIG. 3. The table 500 is an example of a user state/possible action pair (e.g., StateA/Action 1 as shown in FIG. 3) showing the probability 308a-c for a possible new user state (e.g., the new user states 310a-c) for a particular action (e.g., Action 1), respectively, if a particular action (e.g., Action 1) is performed while the user is in a current state (e.g., State A). In the example table 500 shown in FIG. 5, an estimated value (e.g., estimated new state values 508a-c) can be associated with each possible new user state (e.g., the new user states 310a-c) for a particular action (e.g., Action 1), respectively. For example, referring to FIG. 1-4, the action decision module 144 can use the estimated new state values 508a-c associated with each possible new user state (e.g., the new user states 310a-c), and the probability 308a-c for a possible new user state (e.g., the new user states 310a-c) to determine a best proposed action (e.g., the proposed action 212) for performing by the action performing service(s) 146 resulting in the action 214 that is provided to the computing device 102a.

In some implementations, the action decision module 144 can calculate (determine) an overall score 510 (expected value) for a user state/possible action pair (e.g., State A/Action 1), where State A can be considered the current state. For any given state (e.g., the current state, State A) and user action (e.g., Action 1), there can be multiple next states (new states 502) (e.g., State B 310a, State C 310b, State D 310c). A probability 504, P(s′|s, a), is the probability of transitioning from the current state, State A(s), to each of the new states 502 (s) (e.g., State B 310a, State C 310b, State D 310c) given the performing of the user action (a) (e.g., Action 1) while in the current state (e.g., State A). In some implementations, as described herein, referring to FIG. 4, the process 400 for evaluating user state/possible action pairs can be performed for multiple (a plurality of, M number of) user state/potential action pairs (e.g., State A/Action 1, State A/Action 2, . . . State A/Action M).

A reward function , R(s, s′, a), can be a score associated with a new state (s) when a particular action (e.g., Action 1 (a)) is taken while in a current state (s) (e.g., State A (s)). The action modeling module 148 can determine (calculate) a reward function and associate it with a user state/possible action pair (e.g., State A/Action 1).

The action decision module 144 can calculate (determine) an overall estimated value for each new state 310a-c. For example, the state-value model 220 can output a value function, V(s′) (new state value 506 (s′) (e.g., estimated new state values 508a-c)) for each respective new state 502 (e.g., State B 310a, State C 310b, State D 310c. The overall score 510 for the user state/possible action pair, (Q(s,a)), (e.g., State A/Action 1) associates a score with the user state/action pair (e.g., State A/Action 1). The overall score 510 can be calculated (computed) as the sum of the reward function R(s, a) plus a probability-weighted sum of values for all potential next states s′ that could result from taking an action a.

Q(s, a)=ρ{s′}P(s′|s, a)[R(s, s′, a)+γ*V(s′)] Equation 1:

where s=a current state, a=an action, s′=a next state, P(s′|s, a) is the probability of transitioning from the current state s to a new state s′ when action a is performed, R(s, s′, a) is the reward score associated with a new state s′ when action a is taken while in a current state s, γ is the weight, and V(s′) is the value function for a new state s′.

The action decision module 144 can calculate (determine) an overall estimated value for multiple user state/possible action pairs (e.g., State A/Action 1, State A/Action 2, . . . State A/Action M) as described with reference to FIGS. 1-5. Equation 1, Q(s,a), can be calculated for State A in combination with each Action 1 to M (e.g., Q(State A, Action 1), Q(State A, Action 2), . . . Q(State A, Action M)). The action decision module 144 can identify (select or pick) a best user state/possible action pair by identifying the user state/possible action pair with the highest (largest, greater) overall estimated value or score. In cases where the overall estimated value of each user state/possible action pairs are equal, the action decision module 144 may use other criterion to identify (select or pick) a best user state/possible action pair. The potential action for the best user state/possible action pair is then provided as the proposed action to the action performing service(s) 146 which provides the action 214 to the web application 128 executing on the computing device 102a (e.g., a computing device of the user).

As described herein, a user can interact with the web application 128 resulting in information and data related to the interactions (and associated with the particular action) being provided to the application module 138 for further inclusion in the user data record(s) 160 stored in the database 142c. The action modeling module 148 can use new and updated data and information stored in the user data record(s) 160 to update (modify) a prediction of a new user state and to update (modify) a determined probability of the user transitioning from the current state to another state when the particular action is performed on the user. The action decision module 144 can receive updated user state/possible action pairs from the action modeling module 148, where the updating of the user state/possible action pairs may have occurred based on the interactions of the user with the action as provided to the web application 128.

Referring to FIGS. 1, 2, and 4, the action decision module 144 can interface to the action performing service(s) 146. The action performing service(s) 146 include services that can interface with an action in order to provide and receive user information and data. The action performing service(s) 146 can include, but are not limited to, a messaging service, a support ticket system service, and a tracking system service. For example, the messaging service can send an email to a user. For example, the messaging service can send an SMS text message as a mobile push notification to a mobile device of a user. For example, a ticket can be filed in the support ticket system service. The ticket can indicate that a support specialist should check-in with the user at a particular time. The support ticket system service can then, for example, use the messaging service to contact the user. The tracking system service can flag a user for review on a dashboard.

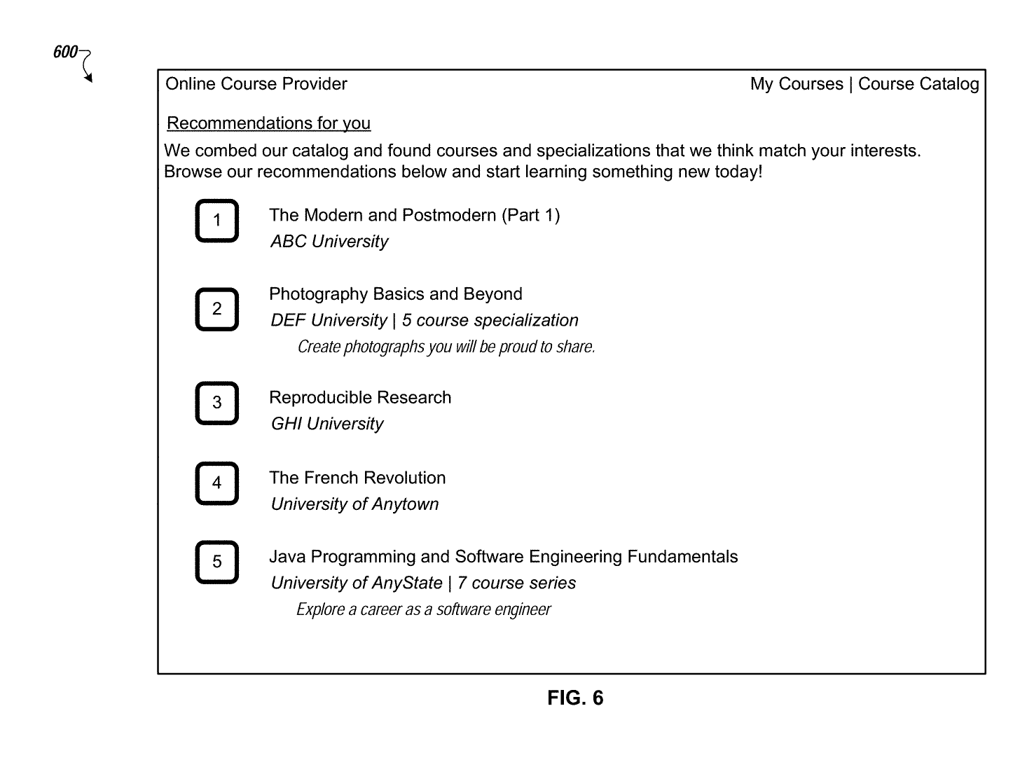

FIG. 6 is an illustration of an example recommendation email message 600 that a messaging service included in action performing service(s) (e.g., the action performing service(s) 146 as shown in FIGS. 1 and 2) can provide as an action (e.g., action 214) to a computing device (e.g., the computing device 102a) of a user. As described herein, the recommendation email 600 can be provided by the web application 128. A user can interact with icons and selections included in the email message 600, providing information and data related to the interactions and associated with the action (e.g., the email message 600) to the data gathering application 164. The data gathering application 164 can provide the data and information for updating and/or adding to the stored user data record(s) 160 included in the database 142c.

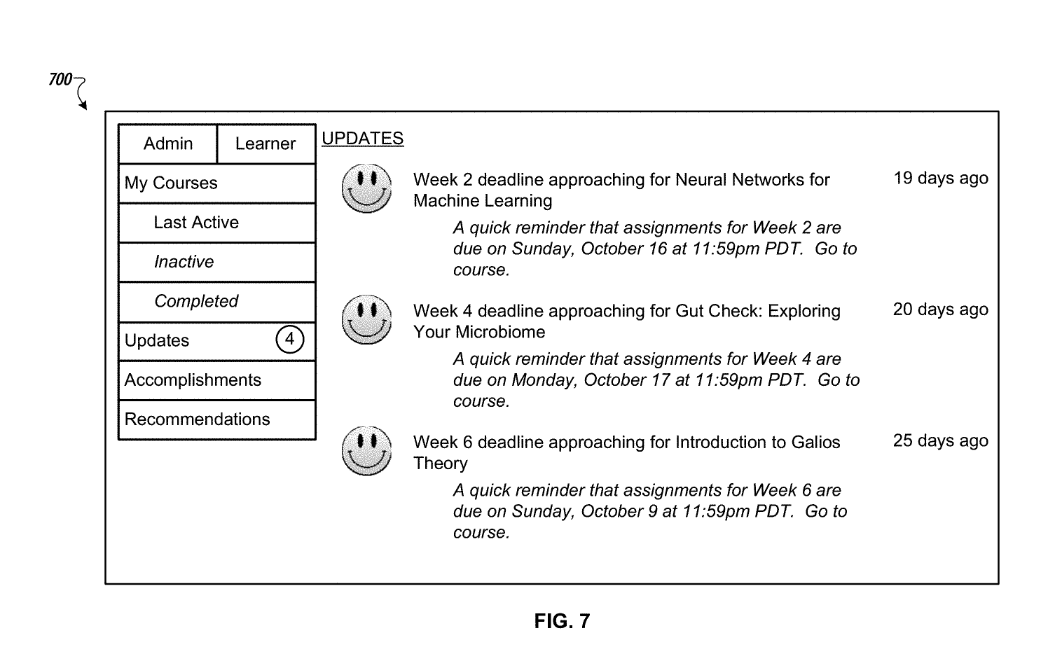

FIG. 7 is an illustration of an example on-platform message 700 to a user. For example, an on-platform message can be a message provide to a user while they are interacting with the web application 128. In the example of the web application 128 being an online course, the on-platform message 700 can include information and prompts for the user to perform particular tasks related to the online course. For example, a tracking system service can provide the on-platform message 700 as it tracks the progress and status of a learner (the user) of the online course.

Referring to FIG. 1 and as described herein, the system 100 can provide an online course to a learner. The system 100 can determine that a learner may be falling behind in the course (e.g., not completing quizzes and assignments, not attending recent course sessions). Referring to FIG. 2, the process 200 can determine a best action as the sending of an email to the learner reminding the learner of upcoming deadlines. In another example, the system 100 can determine that a user has completed a significant number of online courses towards a particular area of concentration. Referring to FIG. 2, the process 200 can determine a best action as the use of the tracking system service to provide an on-platform message suggesting a degree program to the learner. In another example, the system 100 can determine that a user is encountering difficulties with a degree program they are currently enrolled in. Referring to FIG. 2, the process 200 can determine a best action as the filing of a ticket in the support ticket system service. The ticket can indicate that a support specialist should check-in with the user. The support ticket system service can then, for example, use the messaging service to contact the user.

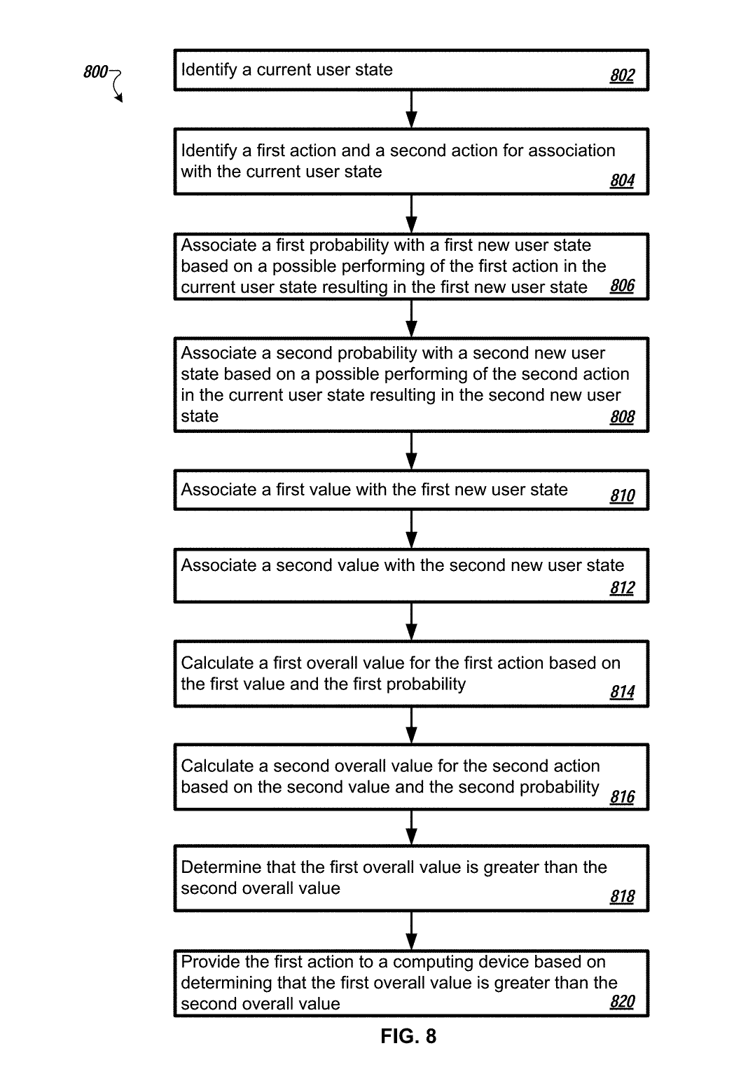

FIG. 8 is a flowchart that illustrates a method 800 for providing a proactive user experience. In some implementations, the systems and processes described herein can implement the method 800. For example, the method 800 can be described referring to FIGS. 1-7.

A current user state is identified (block 802). For example, referring to FIG. 1, the user state modeling module 140 can generate a user state table 216 and/or a high-dimensional vector 208 for use in determining a current user state. A first action and a second action for association with the current user state is identified (block 804). For example, the action modeling module 148 can access the action list 218 to identify the first action and the second action. A first probability is associated with a first new user state based on a possible performing of the first action in the current user state resulting in the first new user state (block 806). A second probability is associated with a second new user state based on a possible performing of the second action in the current user state resulting in the second new user state (block 808). For example, the action modeling module 148 can utilize data and information included in the action list 218 to associate a probability with a new user state based on the performing of an action on a current user state. A first value is associated with the first new user state (block 810). A second value is associated with the second new user state (block 812). For example, the action decision module 144 can use the user state and potential actions 210 along with information and data provided by a state-value model 220 to identify the best action to take. The state-value model 220 can include an associated estimated value for the user when in that particular state.

A first overall value for the first action can be calculated based on the first value and the first probability (block 814). A second overall value for the second action can be calculated based on the second value and the second probability (block 816). It is determined that the first overall value is greater than the second overall value (block 818). The first action is provided to a computing device based on determining that the first overall value is greater than the second overall value (block 820). For example, referring to FIG. 5, the action decision module 144 can calculate (determine) an overall estimated value for each user state/possible action pair. The action decision module 144 can identify (select or pick) a best user state/possible action pair by identifying the user state/possible action pair with the highest (largest, greater) overall estimated value. The first action is provided to the action performing service(s) 146 which includes one or more services needed to provide the action 214 to the web application 128 executing on the computing device 102a (e.g., a computing device of the user).

Though a proactive user experience is described for learners of an online course, any application provided by a computing system that a user can interact with on a computing device can utilize the systems and techniques described herein to provide a user with a proactive experience as also described herein.

For example, the web application can be for an online course provider. The web application can provide one or more online courses. The web application can gather data related to an interaction of a user (or a group of users) with an online course. For example, the web application can gather data related to an interaction of a user with the web application as a user browses the web page for the web application. The web application can aggregate the gathered data and information related to the interaction of the user and, for example, store it in a database or repository for the online course provider. The online course provider can use the aggregated gathered data and information to construct a state-value model whose input is a current user state and whose output is an estimated value of a user in the current state. For example, the estimated value of the user can be a predicted six month revenue of the user. The reward function R(s, s′, a) can measure an amount of money paid by a learner to an online course provider, as implied by a transition from state s to state s′. The value function V(s) can represent an expected sum of discounted future rewards associated with a particular policy.

The state-value model can evaluate a current state/possible action pair to determine a probability of the user transitioning from the current state to another state when a particular action is performed on the user. For example, a learner is not currently enrolled in a degree program. A current state of the learner can be that they just completed an online course. This data and information can be input to (taken in by) the state-value model. The state-value model can estimate that if the action of sending the learner an email about degree programs is taken, there is a 20 percent probability (chance) that the learner will enroll in a degree program, transitioning the learner from the current state (completion of an online course) to another state (student enrolled in a degree program). A decision as to what a best action to take can be based on the state-value model. The methods and systems can determine a response of the user to the action and can use this information to improve the state-value model.

In another example, the system, processes, and methods described herein can be used to determine what marketing emails to send a user over the course of a year in order to maximize customer lifetime value. In another example, the system, processes, and methods described herein when implemented by an online course provider can be used to select particular reminder emails to send a learner during the few weeks of an online course in order to maximize course module completion rates. In another example, the system, processes, and methods described herein when implemented by an online course provider can be used to select which practice questions to present a learner within a single learning session in order to maximize learner engagement with the online course.

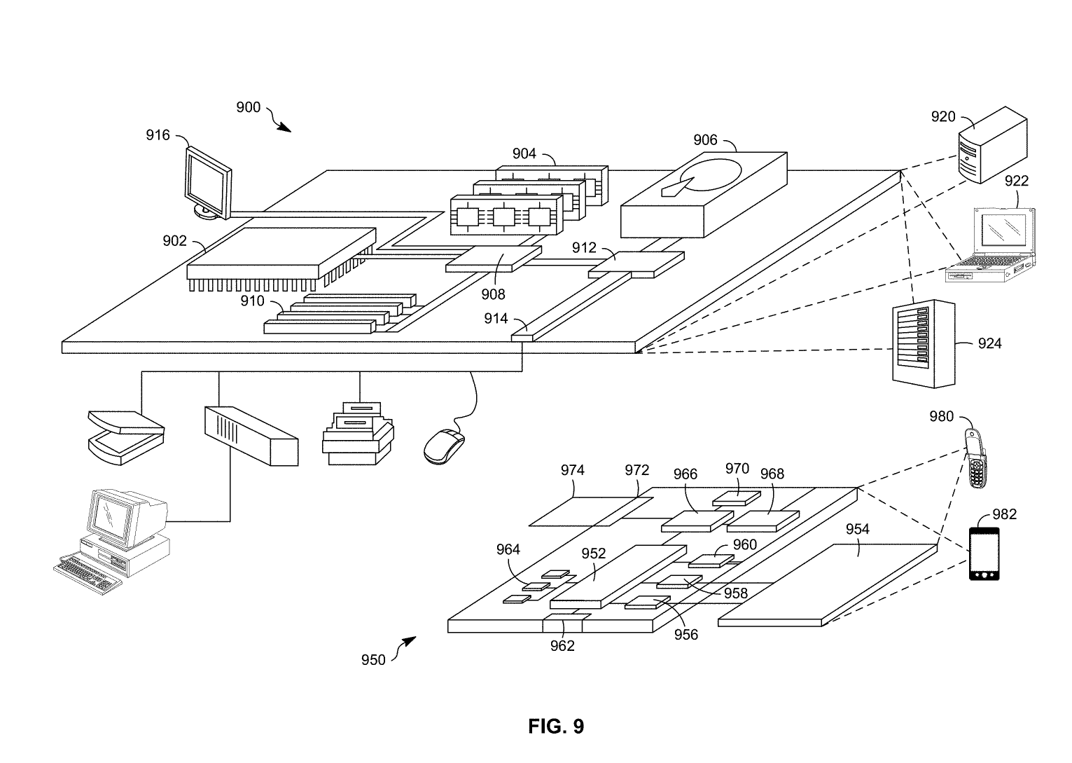

FIG. 9 shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
identifying, by a computer system, a current user state;
identifying a first action and a second action for association with the current user state;
associating a first probability with a first new user state based on a possible performing of the first action in the current user state resulting in the first new user state;
associating a second probability with a second new user state based on a possible performing of the second action in the current user state resulting in the second new user state;
associating a first value with the first new user state;
associating a second value with the second new user state;
calculating a first overall value for the first action based on the first value and the first probability;
calculating a second overall value for the second action based on the second value and the second probability;
determining whether the first overall value is greater than the second overall value; and
providing, by the computer system and to a computing device, the first action to the computing device based on determining that the first overall value is greater than the second overall value.

2. The method of claim 1, further comprising:
providing, by the computer system and to a computing device, the second action to the computing device based on determining that the second overall value is greater than the first overall value.

3. The method of claim 1, further comprising:
associating a third probability with a third new user state based on a possible performing of the first action in the current user state resulting in the third new user state.

4. The method of claim 3,
further comprising associating a third value with the third new user state; and
wherein calculating the first overall value for the first action is further based on the third value and the third probability.

5. The method of claim 1, further comprising:
receiving, by the computer system and from the computing device, data representative of interactions with an action; and
storing, by the computer system and in a database, the data representative of the interactions with the action.

6. The method of claim 5, wherein the database includes user data records, and wherein the storing of the data representative of the interactions with the action is stored in the user data records.

7. The method of claim 1, wherein the first value and the second value are provided by a state-value model.

8. A system comprising:
a database including a plurality of user data records;
a user state modeling module configured to:
receive user data from the plurality of user data records; and
output a current user state;
an action modeling module configured to:
receive the current user state;
output a current state/first action pair including a first probability associated with a first new user state based on a possible performing of the first action in the current user state resulting in the first new user state; and
output a current state/second action pair including a second probability associated with a second new user state based on a possible performing of the second action in the current user state resulting in the second new user state; and
an action decision module configured to:
receive the current state/first action pair and the current state/second action pair;
associate a first value with the first new user state included in the current state/first action pair;
associate a second value with the second new user state included in the current state/second action pair;
calculate a first overall value for the first action based on the first value and the first probability;
calculate a second overall value for the second action based on the second value and the second probability;
determine whether the first overall value is greater than the second overall value; and
output the first action based on determining that the first overall value is greater than the second overall value.

9. The system of claim 8, wherein the action modeling module is further configured to:
output the current state/first action pair further including a third probability associated with a third new user state based on a possible performing of the first action in the current user state resulting in the third new user state.

10. The system of claim 9, wherein the action decision module is further configured to:
associate a third value with the third new user state included in the current state/first action pair; and
calculate the first overall value for the first action further based on the third value and the third probability.

11. The system of claim 8, wherein the plurality of user data records include data representative of interactions with one or more actions.

12. The system of claim 8, further comprising a state-value model configured to provide the first value and the second value.

13. The system of claim 8, further comprising a user state table configured to store the first user state and the second user state.

14. The system of claim 8, further comprising action performing services configured to:
receive the first action; and
include one or more services for providing the action to a computing device.

15. A non-transitory, machine-readable medium having instructions stored thereon, the instructions, when executed by a processor, cause a computer system to:
identify, by the computer system, a current user state;
identify a first action and a second action for association with the current user state;
associate a first probability with a first new user state based on a possible performing of the first action in the current user state resulting in the first new user state;
associate a second probability with a second new user state based on a possible performing of the second action in the current user state resulting in the second new user state;
associate a first value with the first new user state;
associate a second value with the second new user state;
calculate a first overall value for the first action based on the first value and the first probability;
calculate a second overall value for the second action based on the second value and the second probability;
determine whether the first overall value is greater than the second overall value; and
provide, by the computer system and to a computing device, the first action to the computing device based on determining that the first overall value is greater than the second overall value.

16. The non-transitory, machine-readable medium of claim 15, wherein the instructions, when executed by the processor, further cause the computer system to:
provide, to a computing device, the second action to the computing device based on determining that the second overall value is greater than the first overall value.

17. The non-transitory, machine-readable medium of claim 15, wherein the instructions, when executed by the processor, further cause the computer system to:
associate a third probability with a third new user state based on a possible performing of the first action in the current user state resulting in the third new user state.

18. The non-transitory, machine-readable medium of claim 17, wherein the instructions, when executed by the processor, further cause the computer system to associate a third value with the third new user state; and wherein calculating the first overall value for the first action is further based on the third value and the third probability.

19. The non-transitory, machine-readable medium of claim 15, wherein the instructions, when executed by the processor, further cause the computer system to:
receive, from the computing device, data representative of interactions with the action; and
store the data representative of the interactions with the action.

20. The non-transitory, machine-readable medium of claim 15, wherein the first value and the second value are provided by a state-value model.
